(19) United States
(12) Patent Application Publication
(10) Pub. No.: US 2007/0106914 A1
(43) Pub. Date: May 10, 2007

(54) Power management by adding special instructions during program translation

(76) Inventors: Kalyan Muthukumar, Bangalore (IN); Srinivasa Ramakrishna STG, Visakhapatnam (IN); Gautam Doshi, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/268,985

(22) Filed: Nov. 7, 2005

(51) Int. Cl. G06F 1/00

(52) U.S. Cl. 713/300

(57) ABSTRACT

While translating a program for execution by a first electronic device, instructions are generated based on the program, and a portion of the instructions are analyzed to determine whether a functional unit of the first device will be used by the portion. A special instruction is added to these instructions, that indicates a power down operation to reduce power consumption by the functional unit. The special instruction is compatible with a second electronic device that is not capable of the power down operation. Other embodiments are also described and claimed.

### BACKGROUND

An embodiment of the invention relates to power management in a computer system, and, in particular, to controlling the power consumption of an electronic device such as a processor. Other embodiments are also described.

Power consumption in computer systems tends to increase every generation. It is becoming increasingly important to properly manage the power consumption of individual electronic devices of a computer system. This is especially true with advanced high performance processors, also known as central processing units or CPUs, which are becoming larger and have greater transistor density, making it difficult to dissipate the heat that they produce while running at elevated clock frequencies. A processor may have several functional units such as a cache, a bus interface, a register file, an arithmetic logic unit, a floating point unit, a single instruction multiple data execution unit, and a multiple instruction multiple data execution unit. Each of these units consumes power, both during active operation, as well as while being idle.

Several methods have been employed to manage and therefore limit the power consumption of a processor to meet a given power envelope. For example, since power consumption is proportional to the frequency of the clock that sequences operation of the processor, some power management techniques concentrate on reducing the processor clock speed during periods of inactivity or when the operations performed by the processor do not require speedy execution. Such methods predict, during execution of a program, when the functional units will be idling during execution of a program, and then reduce the clock frequency or supply voltage to an appropriate level. This may require that the functional units be monitored by the processor during program execution.

Other methods simply shut down large portions of the system in response to a keyboard idle timer expiring, indicating that the system is likely not being used as heavily, therefore justifying a partial or complete shutdown of certain functional units.

Yet another method is referred to as compiler assisted power management. That technique recognizes that the electronic instructions executed by the functional units of a computer system are derived from computer programs, such as software applications, operating systems, etc., by a compiler. The compiler translates the high level operations described in a computer program and organizes the translated operations into a sequence of low level instructions. These instructions are then packaged sequentially into an executable file that can be loaded into computer memory, and executed by the functional units of a processor. Compiler assisted power management capitalizes on the awareness of the processor's internal architecture by the compiler, and uses that knowledge to generate hints or suggestions in the form of power-control instructions that are embedded in the resulting, translated sequence of instructions. These instructions can be used to power up functional units so that they are ready to execute when necessary. The instructions may also be used to reduce or turnoff power consumption in certain functional units that are not in use, or that are idling. The placement of these instructions is based upon an analysis of the computer program and the resulting instructions, at the translation stage, relieving the processor and other electronic devices of the need to make decisions about when to power down certain functional units. Of course, to take advantage of these power controlling instructions, the processor needs to have the appropriate internal abilities, including hardware and/or microcode capability, to recognize and implement the power down or power up requests that it encounters while executing a sequence of instructions.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a block diagram of a processor, according to an embodiment of the invention.

FIG. 2 depicts a program translation operation, according to an embodiment of the invention.

FIG. 3 shows a sequence of instructions obtained from translating a program, that includes power down and power up NOP instructions.

FIG. 4 shows some constituent parts of a special instruction, in accordance with an embodiment of the invention.

### DETAILED DESCRIPTION

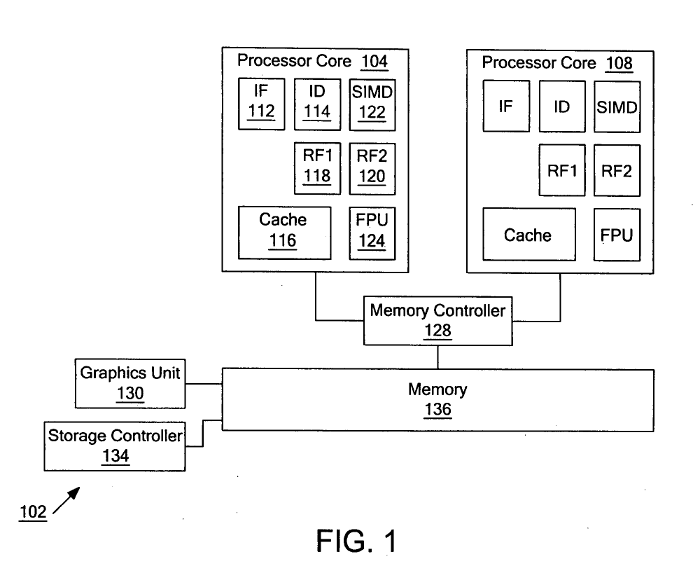

A method and apparatus for compiler-assisted power management is described here that uses special instructions. Beginning with FIG. 1, a block diagram of an electronic device 102 that can be modified to have power management capability that is controlled by special instructions is shown. The example here is that of a multi-core processor, including cores 104 and 108, although other electronic devices, including single core processors, may also benefit from the different embodiments of the invention. The device 102 may be a general purpose processor such as one that is compatible with the IA-32 Instruction Set Architecture (ISA) of Intel Corp., Santa Clara, Calif., or the ITANIUM ISA, also by Intel Corp. As an alternative, the processor may be a more specialized device, such as one that is used in other types of computer systems, e.g, a network router, a network switch, a cellular telephone, or a dedicated video game computer.

The device 102 has a number of functional units, such as those shown in FIG. 1, namely an instruction fetch unit 112, an instruction decode unit 114, a cache 116, register files 118, 120, single instruction multiple data execution unit 122, and a floating point execution unit 124. Additional functional units (not shown) may include buffers and bus interface units. Each of these functional units consumes power while being accessed by electronic instructions (e.g., while executing them). In addition, they consume power even when idle. Typically, the instructions are obtained from memory 136 and/or cache 116. Some of the functional units shown in FIG. 1, including the graphics processing unit 130 (dedicated for executing image processing tasks), the storage controller 134 (dedicated for executing mass storage read and write operations), the memory 136, and the memory controller 128 may be off-chip to the processor cores 104, 108 and/or considered separate components. The computer system (of which the processor is a component) will include additional components, some of which may also be considered to be “functional units of an electronic device” as used here, e.g. a network interface controller, or an encryption unit (not shown). Another functional unit that may be modified to take advantage of compiler-assisted power management is an MMX unit of an IA-32 processor.

In accordance with an embodiment of the invention, the electronic device shown in FIG. 1 may be modified with the appropriate circuitry that allows one or more of the functional units to be independently controlled for power management, in accordance with special instructions that have been embedded in a program and are encountered by the device during its execution of the program. For example, the floating point unit (FPU) 124 may be enhanced with clock control circuitry that allows the clock that sequences operation of the FPU to be slowed down or even stopped on command. There may also be circuitry that controls the power supply voltage to the FPU, for example, allowing the FPU to either operate at a lower voltage (lower performance, but also lower power consumption), or alternatively essentially shutting down the floating point unit. In most instances, it is desirable that these so called power down and power up operations not impact any of the other functional units that may continue to be executing at full power, for instance.

In addition to this power management capability, an embodiment of the invention modifies the instruction decode (ID) unit 114 of a processor, so that it can detect special instructions that have been inserted into the sequence of processor instructions that constitute the program or translated code being executed. The special instruction may be one that does not affect the result of any computation in the generated instructions. In other words, the computation results (from executing the surrounding instructions) would be the same, whether or not the special instruction were present. An example is to modify the data structure for a conventional no-operation (NOP) instruction, to also indicate a power control operation for a particular functional unit of the processor. The modified data structure should still be recognizable as a NOP instruction.

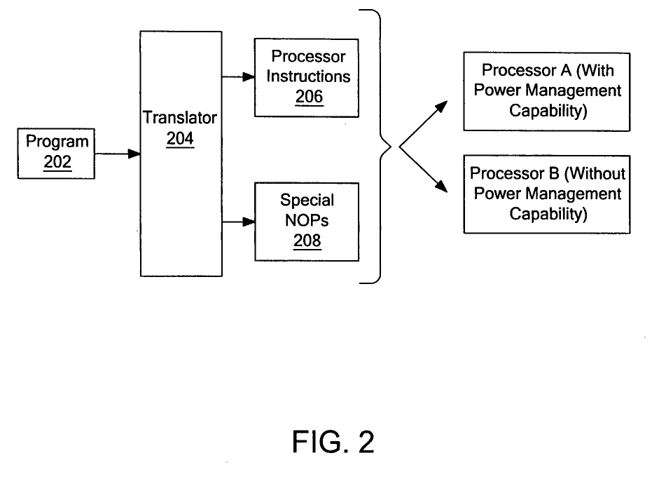

For example, in the case of an IA-32 ISA compliant processor, in addition to detecting that an opcode of an instruction refers to a conventional, ISA NOP instruction, the ID unit 114 would also be able to detect that an operand of that instruction is indicating a request to either power up or power down a selected one of the functional units of the processor. FIG. 2 shows a process of compiler-assisted power management that inserts special NOPs into the translated code.

In FIG. 2, beginning with a program 202, a translator 204 generates processor instructions based on the program 202. The translator 204 may be a compiler, that translates high level programming language code such as Fortran or C++ code into low level instructions, such as assembly language instructions for processor A. As an alternative, the translator may be a just-in-time (JIT) compiler, a Java Virtual Machine (JVM), an interpreter, or even an assembler. The translator 204 analyzes a portion of the instructions 206, to determine whether a functional unit of processor A (for which it is translating) will be used by that portion.

One or more special NOPs 208 are added to the generated, processor instructions 206. A special NOP may indicate a power down operation to reduce power consumption by its corresponding functional unit. Such special NOPs 208 are also compatible with another processor, processor B, that is not capable of the power down operation. Processor B may be a previous generation of processor A, compatible with the same ISA. In other words, the processor instructions 206, with the added special NOPs 208, can be executed by two kinds of processors, namely one that has power management capability associated with the special NOPs, and one that does not. An instruction is said to be “compatible” with the processor if it is not an invalid or illegal instruction. Note that in this case, the addition of the special instructions yields the same computation results, due to “no operation” being added, though perhaps with somewhat different delays.

The analysis of the program to determine whether a particular functional unit is used may be completely automated, for example, by the translator repeatedly scanning the entire generated code for the presence of instructions that access each functional unit. However, a provision may be made to allow the translator to accept instructions from the user of the translator, to “manually” add the special instructions to certain parts of the code. For example, this may be a compiler directive, such as a pragma statement, that is placed by the user either at a high level or at a low level version of the program, and that instructs the compiler to insert the selected special instruction.

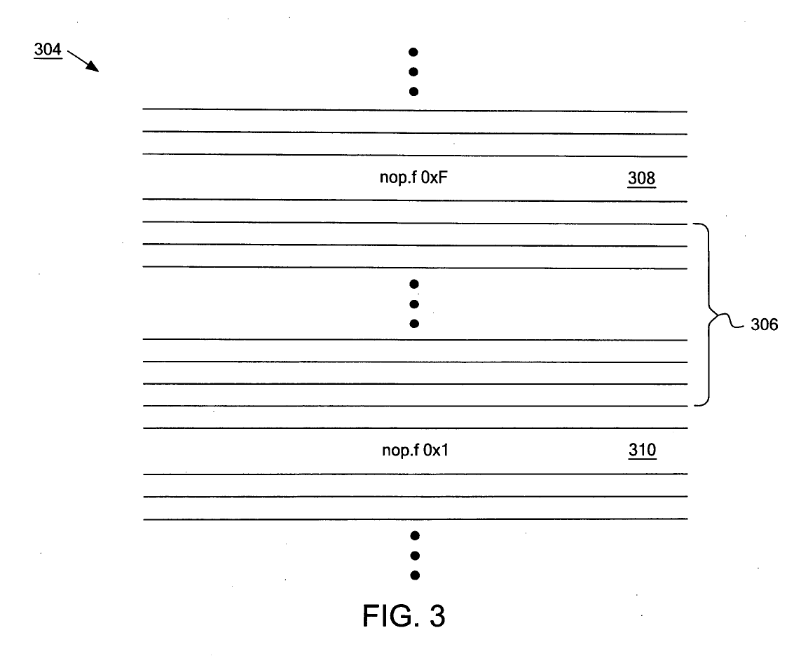

Turning now to FIG. 3, a sequence of instructions 304 that have been obtained by translating a program are shown. A power down NOP instruction 308 has been inserted by a compiler, one or more instructions prior to the start of a portion 306. In addition, a power up NOP instruction 310 has been inserted, one or more instructions after the portion 306. Note that both of these NOP instructions 308, 310 are compatible with a processor that is not capable of the indicated power down, power up operations. The portion 306 may be a program loop that, as analyzed and predicted by the compiler, is likely to be executed a relatively large number of times, for a significant period of time. Assume in this case that the portion 306 does not use a floating point unit of the processor, e.g. only integer operations are performed in the portion 306. As a result, the floating point unit is likely to remain idle for a very long time, as portion 306 executes. In the meantime, the floating point unit consumes leakage power during such idle times. Such leakage power may be expected to increase, in relation to the total power consumption of the processor, as processor designs use smaller transistor feature sizes of 90 nanometers and 65 nanometers, for example. The special NOP instructions in that case may improve power efficiency, if the processor has circuitry that completely turns off the floating point unit or puts it into a relatively deep sleep state. This state will be entered in response to the processor encountering the first NOP instruction 308, and exited upon encountering the second NOP instruction 310.

If the compiler detects that floating point type instructions will not be used for a considerable period of time, by a certain portion of the code to be executed, it may insert a power down NOP immediately after the last instance of an instruction that uses the FP unit. A power up NOP may also be inserted, to “wake up” the FP unit (early enough so that the FP unit is ready to execute the next instance of a floating point instruction).

As mentioned above, the portion 306 could be a program loop, but alternatively, it may be the entire code for a particular high level function or routine. As anther alternative, the portion 306 may be a non-loop region, inside a routine. For better overall efficiency, if a particular functional unit requires a relatively long period of time (e.g., measured in terms of processor cycles) to resume full power operation, then it may be more efficient to insert the corresponding NOPs around only the larger chunks of code (or those that are executed many times, in the case of a loop). That is because, for smaller sections of code, such as only a handful of instructions that are not executed repeatedly as part of a hot loop, the delay associated with putting to sleep and/or waking up one or more functional units may reduce overall performance, while gaining little in terms of a reduction in power consumption.

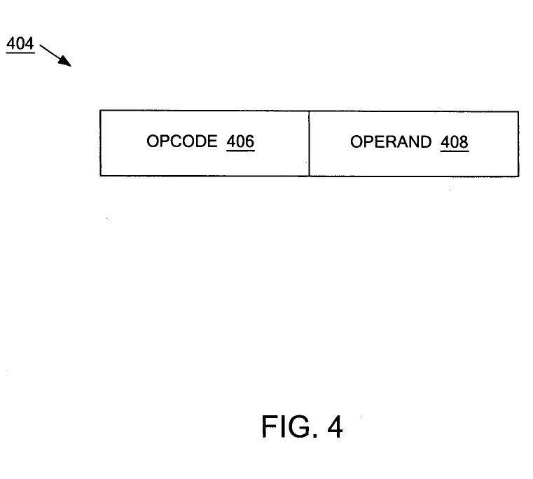

Turning now to FIG. 4, a data structure 404 is shown that represents a special instruction indicating a power up or power down operation to a processor. The structure 404 includes a typical opcode 406, and a special operand 408. A typical processor may ignore the operand 408, if the opcode 406 is that of a NOP instruction. Note that the ISA may define more than one opcode for a NOP instruction. The operand 408 may thus be a “don't care” value, for purposes of the NOP instruction.

Modifying the operand field to obtain the special instruction is a flexible technique and lends itself to change and upgrades. The operand 408 may be used to differentiate between many different types of functional units and their corresponding power down and power up operations. In addition, because of the relatively large number of bits in the operand field of a NOP instruction (e.g., 21 bits for that of the ITANIUM ISA), many more levels of “sleep” states may be added into future generations of the processor.

As an example, “nop.f 0XF” may instruct the processor to “put floating point unit to sleep”, while “nop.f 0X1” may mean “wake up floating point unit”. Note that there may also be different levels of sleep states for a given functional unit. For example, the operand 0XF may signal the processor to place its floating point unit in “light sleep”, while 0XFF may signal “medium sleep”, and 0XFFF may signal “deep sleep”. These different levels of sleep states may refer to one or more combinations of power saving operations such as reduction in frequency or even shutting off of a sequencing clock, and reduction or even shutting off a supply voltage. According to an embodiment of the invention, a compiler may be written to have this knowledge of the power down and power up capabilities that have been built into the processor, for certain individual functional units. Overall power consumption may therefore be better controlled, using the compiler which has a wider view of the code being executed, than a purely hardware or low level decision mechanism that sees only smaller chunks of code at a time. This technique can also supplement existing hardware techniques for power savings.

An embodiment of the invention may be a machine readable medium having stored thereon instructions which program a computer system to perform some of the operations described above, e.g. scanning generated instructions to determine whether a selected one of the functional units of the processor are accessed. In other embodiments, some of these operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

The invention is not limited to the specific embodiments described above. An example special instruction was described above as a modified version of a conventional NOP instruction. However, any other instruction that remains backward compatible (for example, with earlier generation processors), and does not alter the results of the program's computations, despite being modified to indicate a power up or power down operation, may be used. The power control operation could be encoded into the operand, and not the opcode (assuming, of course, that such a modified instruction would be recognized by previous generation processors, or by processors that do not have the power control capability, because of the familiar opcode). Accordingly, other embodiments are within the scope of the claims.

What is claimed is:

1. A method for translating a program, comprising:
while translating a program for execution by a first electronic device,
a) generating instructions based on the program, and analyzing a portion of said instructions to determine whether a functional unit of the first device will be used by said portion; and
b) adding a special instruction to said instructions that indicates a power down operation to reduce power consumption by the functional unit, the special instruction being compatible with a second electronic device that is not capable of the power down operation.

2. The method of claim 1 wherein the program includes high level source code and the generated instructions are assembly language instructions for a processor.

3. The method of claim 1 wherein the portion being analyzed is one of a program loop, a non-loop region, and an entire routine.

4. The method of claim 1 further comprising receiving instructions from a user to add the special instruction.

5. The method of claim 1 wherein the power down operation is one of slowing down a clock to the functional unit and lowering a power supply voltage to the functional unit.

6. The method of claim 1 wherein adding a special instruction comprises inserting the special instruction into a sequence of instructions, before start of said portion.

7. The method of claim 6 further comprising inserting another special instruction into the sequence of instructions, after end of said portion, said another special instruction indicating a power up operation for the functional unit of the first device, and being compatible with the second device, which is not capable of the power up operation.

8. The method of claim 7 wherein said special instruction and said another special instruction have the same opcode and different operands, the opcode being the same as that of a different instruction for the first and second devices.

9. A processor comprising:
a processor core having an instruction decode unit to decode a sequence of processor instructions; and
a plurality of functional units to be accessed by the sequence of processor instructions, wherein the instruction decode unit is to detect a) an opcode of a first instruction as referring to a no-operation (NOP) instruction and b) an operand of the first instruction as requesting one of a power up and power down, of one of the functional units.

10. The processor of claim 9 wherein the processor core is compatible with one of an IA-32 and ITANIUM instruction set architecture.

11. The processor of claim 9 wherein the plurality of functional units comprise a floating point unit, a register file, a single-instruction-multiple-data unit, and a graphics unit.

12. The processor of claim 9 wherein the instruction decode unit is to detect a) an opcode of a second instruction as referring to the no-operation (NOP) instruction and b) an operand of the second instruction as requesting one of a power up and power down, of another one of the functional units.

13. An article of manufacture comprising:
a machine-readable medium having stored therein a program that has been compiled for a first processor, wherein a portion of the program does not use one of a plurality of functional units of the first processor, the program includes a special processor instruction that a) indicates a power management operation to be performed by the first processor on said one of the functional units and b) is compatible with a second processor that is not capable of said power management operation.

14. The article of manufacture of claim 13 wherein the special processor instruction indicates a power down operation on said one of the functional units.

15. The article of manufacture of claim 14 wherein the program includes another special processor instruction that indicates a power up operation on said one of the functional units.

16. An article of manufacture comprising:
a machine-readable medium having stored therein data that when accessed causes a computer system to translate a program into processor instructions for a first processor, analyze said instructions to determine whether there is any portion of the program that will use any one of a plurality of functional units of the first processor, and add a special instruction to said instructions that indicates one of a power up and a power down operation for one of the functional units, the special instruction being compatible with a second processor that is not capable of the power up or power down operation.

17. The article of manufacture of claim 16 wherein the stored data is part of a compiler for the first and second processors.

18. The article of manufacture of claim 16 wherein the data causes the computer system to analyze said instructions by scanning for instructions that access a selected one of the plurality of functional units.

19. The article of manufacture of claim 16 wherein the special instruction has an opcode of a no-operation (NOP) instruction.

20. The article of manufacture of claim 16 wherein the data causes the computer system to add a special instruction that indicates a power up operation for a selected one of the functional units, and wherein the special instruction is inserted into said instructions at a point before the start of a portion that uses the selected functional unit.
